(19) United States
(12) Patent Application Publication
(10) Pub. No.: US 2025/0258936 A1
(43) Pub. Date: Aug. 14, 2025

(54) ELECTRONIC CIRCUIT FOR ENCRYPTING MEMORY DEVICE AND ENCRYPTION METHOD USING THE SAME

(71) Applicant: Samsung Electronics Co., Ltd., Suwon-si, Gyeonggi-do (KR)

(72) Inventors: Jaehyup SEOK, Suwon-si (KR); Jonghyun PARK, Suwon-si (KR); Ingoo HEO, Suwon-si (KR)

(73) Assignee: Samsung Electronics Co., Ltd., Suwon-si, Gyeonggi-do (KR)

(21) Appl. No.: 18/999,082

(22) Filed: Dec. 23, 2024

(30) Foreign Application Priority Data
Feb. 13, 2024 (KR) 10-2024-0020468

(51) Int. Cl. G06F 21/60; H04L 9/08

(52) U.S. Cl. CPC G06F 21/602; H04L 9/0869

(57) ABSTRACT

The electronic circuit includes an encryption circuit that includes a cache memory storing an encryption variable and receives a first encryption request for first data stored in a first area and a second encryption request for second data stored in a second area, a scheduler that transmits the second encryption request to the memory device when a first encryption variable for the first area is not stored in the cache memory and a second encryption variable for the second area is stored in the cache memory, and a variable generation circuit that generates the first encryption variable while the encryption circuit encrypts the second data received from the memory device based on the second encryption variable based on and/or in response to the second encryption request, and the scheduler transmits the first encryption request to the memory device in response to a determination that the first encryption variable is generated.

### CROSS-REFERENCE TO RELATED APPLICATIONS

This application claims priority under 35 U.S.C. § 119 to Korean Patent Application No. 10-2024-0020468 filed on Feb. 13, 2024, in the Korean Intellectual Property Office, the disclosures of which are incorporated by reference herein in their entireties.

### BACKGROUND

Embodiments of the present disclosure described herein relate to an electronic circuit for encrypting a memory device, and more particularly, relate to an encryption method using the same.

Nowadays, security and protection of data stored in a memory device are becoming important.

Consequently, there is an increasing demand on an intellectual property (IP) or an electronic circuit designed to encrypt data stored in a memory device.

In particular, in cases wherein a host (or system) connected to a memory device is required, in some cases, one or more electronic circuit support encryption for the memory device based on a plurality of encryption variables.

However, as the number of hosts connected to the memory device and the number of applications supported by the memory device increase, the number of encryption variables which the electronic circuit requires may increase.

When the electronic circuit stores all encryption variables required for the memory device, the size of the electronic circuit may increase.

Accordingly, an encrypting method is used in which the electronic circuit stores only some of the encryption variables required for the memory device and acquires (or generates) encryption variables not stored therein from the memory device to perform encryption.

However, in this case, as the electronic circuit acquires the encryption variables from the memory device based on and/or in response to an order requested for each of a plurality of encryption requests and performs the encryption, the encryption performance (e.g., speed) of the electronic circuit may be degraded.

### SUMMARY

Embodiments of the present disclosure provide an electronic circuit which reduces time required to encrypt data stored in a memory device in response to a plurality of encryption requests.

According to at least one embodiment, an electronic circuit configured to communicate with a memory device includes an encryption circuit including a cache memory storing an encryption variable for some of a plurality of areas of the memory device, and configured to receive a plurality of encryption requests including a first encryption request for first data stored in a first area of the plurality of areas of the memory device and a second encryption request for second data stored in a second area of the plurality of areas of the memory device, a scheduler that transmits the second encryption request to the memory device when a first encryption variable for the first area is not stored in the cache memory and a second encryption variable for the second area is stored in the cache memory, and a variable generation circuit configured to generate the first encryption variable while the encryption circuit encrypts the second data received from the memory device based on the second encryption variable in response to the second encryption request, and the scheduler transmits the first encryption request to the memory device in response to a determination that the first encryption variable is generated.

According to at least one embodiment, an encrypting method of a memory system including an electrical circuit and a memory device including a plurality of areas includes receiving a plurality of encryption requests including a first encryption request for first data stored in a first area of the plurality of areas and a second encryption request for second data stored in a second area of the plurality of areas, transmitting the second encryption request to the memory device in response to a determination that a first encryption variable for the first area is not stored in a cache memory of the electrical circuit and a second encryption variable for the second area is stored in the cache memory, generating the first encryption variable while encrypting the second data received from the memory device based on the second encryption variable, and encrypting the first data based on the generated first encryption variable.

According to at least one embodiment, an electronic circuit configured to communicate with a memory device including a plurality of areas includes an encryption circuit that includes an encryption circuit including a cache memory storing an encryption variable for some of the plurality of areas of the memory device and configured to receive a first encryption request for first data stored in a first area of the plurality of areas and a second encryption request for second data stored in a second area of the plurality of areas, a scheduler that transmits the second encryption request to the memory device when a first encryption variable for the first area is not stored in the cache memory and a second encryption variable for the second area is stored in the cache memory, and a variable acquisition circuit that receives the first encryption variable from the memory device, wherein the electronic circuit is configured such that the encryption circuit encrypts the second data received from the memory device based on the second encryption variable in response to the second encryption request while the variable acquisition circuit receives the first encryption variable and wherein the scheduler is configured to transmit the first encryption request to the memory device in response to a determination that the first encryption variable is received by the variable acquisition circuit.

### BRIEF DESCRIPTION OF THE FIGURES

The above and other objects and features of the present disclosure will become apparent by describing in detail embodiments thereof with reference to the accompanying drawings.

FIG. 1A is a block diagram illustrating a memory system which encrypts data based on an encryption variable stored in a cache memory, according to at least one embodiment of the present disclosure.

FIG. 1B is a block diagram illustrating a memory system which encrypts data by generating an encryption variable, according to at least one embodiment.

FIG. 2 illustrates requests and data which an electronic circuit exchanges with a host and a memory device to encrypt data stored in a memory device, according to at least one embodiment.

FIG. 3A illustrates a configuration in which a scheduler stores a first encryption request among a plurality of encryption requests in a wait buffer, according to at least one embodiment.

FIG. 3B illustrates a configuration in which a wait buffer outputs a first encryption request to an output circuit in response to a first preparation signal, according to at least one embodiment.

FIG. 4A illustrates a sequence in which an electronic circuit encrypts data stored in a memory device in response to each of first to third encryption requests which is sequentially transmitted, according to at least one embodiment.

FIG. 4B illustrates a configuration for encrypting fourth data in response to a fourth encryption request transmitted following a third encryption request, according to at least one embodiment.

FIG. 5 is a block diagram illustrating an electronic circuit further including a variable generation circuit, according to at least one embodiment.

FIG. 6 is a flowchart illustrating an encryption method for a memory device, according to at least one embodiment.

FIG. 7 is a flowchart illustrating a method of generating a first encryption variable, according to at least one embodiment.

FIG. 8 is a flowchart illustrating a method of encrypting first data based on and/or in response to a first encryption request, according to at least one embodiment.

FIG. 9 is a flowchart illustrating a memory system which includes a system-on-chip including a variable acquisition circuit, according to another embodiment.

### DETAILED DESCRIPTION

Hereinafter, embodiments of the present disclosure will be described clearly and in detail so that a person skilled in the technical field of the present disclosure may easily practice the embodiments of the present disclosure.

In the present disclosure, expressions such as “first”, “second”, and the like may modify various components regardless of order and/or importance, and are only used to distinguish one component from another component, and do not limit the order or importance of corresponding components.

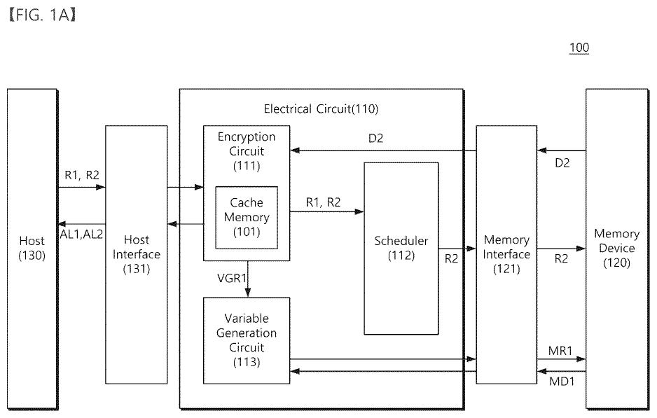

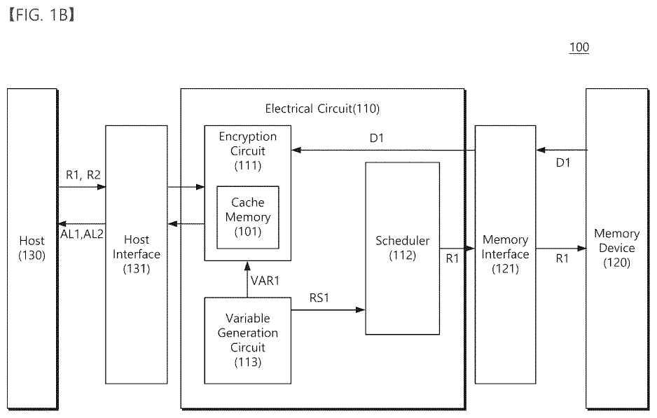

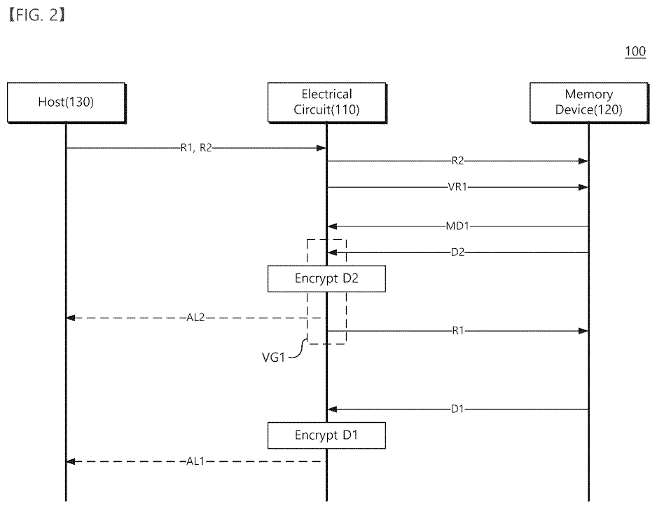

FIG. 1A is a block diagram illustrating a memory system which encrypts data based on an encryption variable stored in a cache memory, according to at least one embodiment of the present disclosure. FIG. 1B is a block diagram illustrating the memory system for encrypting data by generating the encryption variable, according to at least one embodiment. FIG. 2 illustrates requests and data exchanged by an electronic circuit with a host and a memory device to encrypt data stored in the memory device, according to at least one embodiment.

Referring to FIG. 1A and FIG. 1B together, a memory system 100 according to at least one embodiment may include an electronic circuit 110 and a memory device 120, The memory system 100 may further include and/or be connected to a host 130. For example, in the memory system 100, some of the above-described components (e.g., the host 130) may be omitted and/or replaced with other components.

Here, the electronic circuit 110 may be configured to communicate with the host 130 through a host interface 131. For example, the host interface 131 may support at least one protocol of an advanced extendable interface (AXI), an advanced high performance bus (AHB), and an AXI coherency extension (ACE), and/or the like; but is not limited thereto.

Additionally, the electronic circuit 110 may be configured to communicate with the memory device 120 through a memory interface 121.

According to at least one embodiment, the memory system 100 may refer to an integrated circuit, an electronic device or system, a smart phone, a tablet PC, a computer, a server, a workstation, a portable communication terminal, a personal digital assistant (PDA), a portable multimedia player (PMP), and a computing device, a virtual machine, a virtual computing device thereof and/or the like. Alternatively, the memory system 100 may be some of the components included in a computing system such as a graphic card.

According to at least one embodiment, the memory system 100 may include the memory device 120 which stores data.

Here, the memory device 120 is provided as a dynamic random access memory (DRAM) such as a double data rate synchronous dynamic random access memory (DDR SDRAM), a low power double data rate (LPDDR) SDRAM, a graphics double data rate (GDDR) SDRAM, and a Rambus dynamic random access memory (RDRAM). However, embodiments of the present disclosure are not limited thereto, and as an example, the memory device 120 may include a nonvolatile memory such as a flash memory, a magnetic RAM (MRAM), a ferroelectric RAM (FeRAM), a phase change RAM (PRAM), and/or the like a resistive RAM (ReRAM).

The memory system 100 may include the host 130 communicating with the electronic circuit 110.

According to at least one embodiment, the host 130 may be configured to transmit encryption requests R1 and R2 for the memory device 120 to the electronic circuit 110 through the host interface 131.

More specifically, the host 130 may transmit the encryption requests R1 and R2 for at least some of a plurality of areas of the memory device 120 to the electronic circuit 110.

The host 130 may transmit the encryption requests R1 and R2 for stored data in association with at least some of a plurality of applications supported by the memory device 120 to the electronic circuit 110.

In addition, the host 130 may receive notifications AL1 and AL2 output from the electronic circuit 110 in response to a determination that encryption of the memory device 120 is completed through the host interface 131.

As such, communication between the host 130 and the electronic circuit 110 may be referred to as “bi-directional communication”.

Here, for example, the host 130 may refer to as one of an “application processor (AP)”, a “central processing unit (CPU)”, an “external system”, and/or the like; but is not limited thereto.

The memory system 100 may include the electronic circuit 110 configured to encrypt data stored in the memory device 120, e.g., in response to the encryption requests R1 and R2 transmitted from the host 130.

According to at least one embodiment, the electronic circuit 110 may receive the plurality of encryption requests R1 and R2 from the host 130 through the host interface 131.

More specifically, the electronic circuit 110 may encrypt at least some of the data stored in the memory device 120 in response to the encryption requests R1 and R2 transmitted from the host 130.

For example, in response to each of the plurality of encryption requests R1 and R2 transmitted from the host 130, the electronic circuit 110 may encrypt data stored in an area of the memory device 120 specified by each encryption request.

The electronic circuit 110 according to at least one embodiment may be configured to transmit at least some of the plurality of encryption requests R1 and R2 received from the host 130 to the memory device 120.

More specifically, the electronic circuit 110 may transmit at least some of the plurality of encryption requests R1 and R2 to the memory device 120 through the memory interface 121.

For example, the electronic circuit 110 may transmit at least some of the first encryption request R1 and the second encryption request R2 sequentially transmitted from the host 130 to the memory device 120.

The memory device 120 may be further configured to transmit data D1 and D2 stored in an area specified by the encryption requests R1 and R2 to the electronic circuit 110 in response to the encryption requests R1 and R2 transmitted from the electronic circuit 110.

Furthermore, the electronic circuit 110 may encrypt the data D1 and D2 transmitted from the memory device 120.

The electronic circuit 110 may include an encryption circuit 111, a scheduler 112, and a variable generation circuit 113.

More specifically, the electronic circuit 110 may include the encryption circuit 111 which encrypts the data D1 and D2 received from the memory device 120.

According to at least one embodiment, the encryption circuit 111 may include a cache memory 101 which stores encryption variables for some of the plurality of areas of the memory device 120.

However, according to at least one embodiment, the cache memory 101 may be implemented in the electronic circuit 110 as a separate configuration from the encryption circuit 111 and may be connected to the encryption circuit 111.

For example, the cache memory 101 may store a second encryption variable corresponding to a second area among the plurality of areas of the memory device 120.

Here, for example, the encryption variable may include at least one of a key and an initialization vector (IV) for encrypting data stored in each area of the memory device 120. However, the encryption variable is not limited to the above-described example, and may be referred to as a “various security parameter” used to encrypt the data stored in the memory device 120.

In addition, the encryption circuit 111 may receive the encryption requests R1 and R2 for the memory device 120 from the host interface 131 (and/or the host 130).

For example, the encryption circuit 111 may receive the first encryption request R1 for the first data D1 stored in a first area of the memory device 120 and the second encryption request R2 for the second data D2 stored in the second area from the host 130.

Therefore, the encryption circuit 111 may sequentially receive the first encryption request R1 and the second encryption request R2.

Furthermore, the encryption circuit 111 may transmit the encryption requests R1 and R2 to the scheduler 112.

Additionally, the encryption circuit 111 may determine whether an encryption variable for an area of the memory device 120 is stored in the cache memory 101, for which each of the encryption requests R1 and R2 requests encryption.

Accordingly, the encryption circuit 111 may transmit data including information on whether the encryption variables corresponding to each encryption request are stored in the cache memory 101 to the scheduler 112 together with the encryption requests R1 and R2.

For example, the encryption circuit 111 may transmit data including information that a first encryption variable VAR1 for the first area is not stored in the cache memory 101 to the scheduler 112 together with the first encryption request R1.

Additionally, the encryption circuit 111 may transmit data including information that the second encryption variable for the second area is stored in the cache memory 101 to the scheduler 112 together with the second encryption request R2.

Additionally, the electronic circuit 110 may include the scheduler 112 which transmits at least some of the encryption requests R1 and R2 transmitted from the encryption circuit 111 to the memory device 120.

According to at least one embodiment, the scheduler 112 may transmit an encryption request of which the encryption variable corresponding to an area requesting encryption is stored in the cache memory 101 to the memory device 120.

For example, referring to FIG. 1A, when the second encryption variable corresponding to the second area is stored in the cache memory 101, the scheduler 112 may transmit the second encryption request R2 requesting encryption for the second area from among the encryption requests R1 and R2 to the memory device 120.

Here, in response to the second encryption request R2, the memory device 120 may transmit the second data D2 stored in the second area to the encryption circuit 111 (and/or the electronic circuit 110).

Furthermore, the encryption circuit 111 may encrypt the second data D2 based on the second encryption variable.

More specifically, the encryption circuit 111 may encrypt the second data D2 received from the memory device 120 based on the second encryption variable stored in the cache memory 101.

Additionally, referring to FIG. 2, the electronic circuit 110 may transmit the second notification AL2 including information that encryption for the second data D2 is completed to the host 130 in response to a determination that the encryption for the second data D2 is completed.

Additionally, according to at least one embodiment, when the encryption variable corresponding to an area requesting encryption is not stored in the cache memory 101, the encryption circuit 111 may transmit a request for generating the encryption variable to the variable generation circuit 113.

For example, when the first encryption variable VAR1 is not stored in the cache memory 101, the encryption circuit 111 may transmit a first generation request VGR1 for the first encryption variable VAR1 to the variable generation circuit 113 in response to the first encryption request R1.

Additionally, the electronic circuit 110 according to at least one embodiment may include the variable generation circuit 113 which generates the encryption variable for each of the plurality of areas of the memory device 120.

More specifically, referring to FIG. 1A, the variable generation circuit 113 may generate the first encryption variable VAR1 corresponding to the first area of the memory device 120 in response to the first generation request VGR1 transmitted from the encryption circuit 111.

According to at least one embodiment, the variable generation circuit 113 may transmit a first meta request MR1 to the memory device 120 in response to the first generation request VGR1. The first meta request MR1 may include request for first metadata MD1 from the memory device 120.

Here, the variable generation circuit 113 may store location information on a location of the memory device 120, at which the first metadata MD1 for the first area is stored.

Accordingly, the variable generation circuit 113 may transmit the first meta request MR1 including the location information of the first metadata MD1 to the memory device 120.

Additionally, in response to the first meta request MR1 the memory device 120 may transmit the stored first metadata MD1 corresponding to the first encryption variable VAR1 to the variable generation circuit 113 (and/or the electronic circuit 110).

Furthermore, the variable generation circuit 113 may generate the first encryption variable VAR1 based on the first metadata MD1 received from the memory device 120.

Here, the variable generation circuit 113 may generate the first encryption variable VAR1 in response to the first encryption request R1 while the encryption circuit 111 encrypts the second data D2 based on the second encryption variable.

That is, referring to FIG. 2, the variable generation circuit 113 may perform a first generation operation VG1 for generating the first encryption variable VAR1 while the encryption circuit 111 encrypts the second data D2.

Furthermore, referring to FIG. 1B, the variable generation circuit 113 may transmit the first encryption variable VAR1 to the encryption circuit 111 in response to a determination that the first encryption variable VAR1 is generated.

Here, the encryption circuit 111 may store the first encryption variable VAR1 transmitted from the variable generation circuit 113 in the cache memory 101.

For example, the encryption circuit 111 may delete one of encryption variables stored in the cache memory 101 and store the first encryption variable VAR1 in the cache memory 101.

In addition, in response to a determination that the first encryption variable VAR1 is generated, the variable generation circuit 113 may transmit a first preparation signal RS1 including information that the first encryption variable VAR1 is generated to the scheduler 112.

According to at least one embodiment, the scheduler 112 may transmit the first encryption request R1 to the memory device 120 in response to the first preparation signal RS1.

Here, the memory device 120 may transmit the first data D1 stored in the first area to the encryption circuit 111 (and/or the electronic circuit 110) in response to the first encryption request R1 requesting encryption of the first area.

Furthermore, the encryption circuit 111 may encrypt the first data D1 based on the first encryption variable VAR1.

More specifically, the encryption circuit 111 may encrypt the first data D1 received from the memory device 120 based on the first encryption variable VAR1 received from the variable generation circuit 113.

Additionally, referring to FIG. 2, the electronic circuit 110 may transmit the first notification AL1 including information that encryption of the first data D1 is completed to the host 130 in response to a determination that the encryption of the first data D1 is completed.

Referring to the above-described configurations, when the electronic circuit 110 sequentially receives the first encryption request R1 and the second encryption request R2, the electronic circuit 110 may encrypt the second data D2 based on the second encryption variable stored in the cache memory 101.

Additionally, the electronic circuit 110 may generate the first encryption variable VAR1 not stored in the cache memory 101 while encrypting the second data D2 based on the previously stored second encryption variable.

Furthermore, the electronic circuit 110 may encrypt the first data D1 in response to a determination that encryption of the second data D2 is completed and the first encryption variable VAR1 is generated.

That is, while the electronic circuit 110 is first performing encryption in response to encryption request of which the encryption variable is stored from among the plurality of encryption requests, the electronic circuit 110 may generate the encryption variable in response to the encryption request of which the encryption variable is not stored.

Through this, the electronic circuit 110 according to at least one embodiment of the present disclosure may reduce the time required to encrypt the data stored in the memory device 120 in response to the plurality of encryption requests R1 and R2.

Additionally, the electronic circuit 110 may improve encryption performance (e.g., speed) for encrypting data stored in the memory device 120 while the size of cache memory 101 (or the electronic circuit 110) is maintained (and/or reduced).

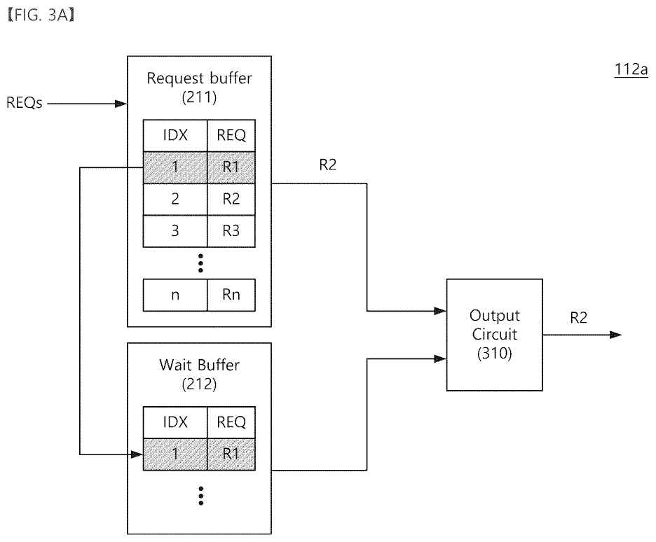

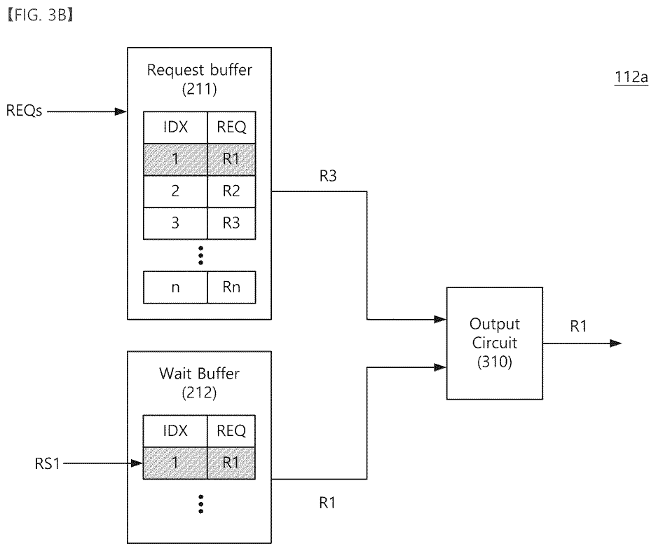

FIG. 3A illustrates a configuration in which a scheduler stores a first encryption request among a plurality of encryption requests in a wait buffer, according to at least one embodiment. FIG. 3B illustrates a configuration in which a wait buffer outputs the first encryption request to an output circuit in response to a first preparation signal, according to at least one embodiment.

Referring to FIG. 3A and FIG. 3B together, a scheduler 112a according to at least one embodiment may include a request buffer 211, a wait buffer 212, and an output circuit 310.

Here, the scheduler 112a of FIG. 3A and FIG. 3B may be understood as an example of the scheduler 112 of FIG. 1A and FIG. 1B.

More specifically, the scheduler 112a may include the request buffer 211 which stores a plurality of encryption requests REQs received from the encryption circuit 111.

According to at least one embodiment, the scheduler 112a may sequentially store the plurality of encryption requests REQs in the request buffer 211 based on and/or in response to an order received from the encryption circuit 111.

For example, the scheduler 112a may store the first encryption request R1 to an n-th encryption request Rn sequentially received from the encryption circuit 111 in the request buffer 211 based on the order in which they are received.

Here, the scheduler 112a may store the plurality of encryption requests REQs in the request buffer 211 together with an index IDX based on the order received from the encryption circuit 111.

Additionally, the scheduler 112a may include the wait buffer 212 which stores encryption requests, of which an encryption variable corresponding to an encryption request area is not stored, in the cache memory 101 (or the encryption circuit 111), from among the plurality of encryption requests REQs.

For example, when the first encryption variable VAR1 for the first area is not stored in the cache memory 101, the scheduler 112a may store the first encryption request R1 requesting encryption for the first area in the wait buffer 212.

Here, the scheduler 112a may store encryption requests, of which the encryption variable corresponding to the area requesting encryption is not stored in the cache memory 101, in the wait buffer 212 together with the index IDX which is based on the order received from the encryption circuit 111.

According to at least one embodiment, the request buffer 211 may sequentially output the encryption requests for an area in association with which an encryption variable is stored in the cache memory 101 from among the encryption requests R1 to Rn stored in the request buffer 211.

For example, referring to FIG. 3A, when the second encryption variable is stored in the cache memory 101, the request buffer 211 may first output the second encryption request R2 for the second area.

Subsequently, referring to FIG. 3B, when the third encryption variable is stored in the cache memory 101, the request buffer 211 may output a third encryption request R3 for the third area.

Additionally, the wait buffer 212 may output an encryption request, of which an encryption variable is generated, from among encryption requests stored in the wait buffer 212.

For example, referring to FIG. 3B, the wait buffer 212 may output the first encryption request R1 stored in the wait buffer 212 in response to the first preparation signal RS1.

Here, the first preparation signal RS1 may be understood as a signal output to the scheduler 112a in response to a determination that the first encryption variable VAR1 is generated by the variable generation circuit 113.

Additionally, the scheduler 112a may further include the output circuit 310 which outputs an encryption request output from the request buffer 211 and the wait buffer 212 to the memory device 120 (and/or the memory interface 121).

For example, referring to FIG. 3A, while the first encryption request R1 is stored in the wait buffer 212, the output circuit 310 may output the second encryption request R2 output from the request buffer 211 to the memory device 120.

Additionally, the output circuit 310 may sequentially output the encryption requests output from the request buffer 211 and the wait buffer 212 to the memory device 120 (and/or the memory interface 121) based on the order (and/or an index IDX) entered into the scheduler 112a.

For example, referring to FIG. 3B, when the request buffer 211 outputs the third encryption request R3 and the wait buffer 212 outputs the first encryption request R1, the output circuit 310 may output the first encryption request R1 to the memory device 120.

Additionally, the output circuit 310 may output the first encryption request R1 and then output the third encryption request R3 to the memory device 120.

That is, when the encryption requests are output from each of the request buffer 211 and the wait buffer 212, the output circuit 310 may sequentially output the encryption requests to the memory device 120 (or the memory interface 121) based on the order in which the encryption requests are input to the scheduler 112a.

Here, in response to the encryption request output from the output circuit 310, the memory device 120 may transmit data stored in an area in which each encryption request requires encryption to the electronic circuit 110.

Furthermore, the electronic circuit 110 (and/or the encryption circuit 111) may sequentially encrypt the data transferred from the memory device 120 in response to the encryption variable corresponding to the area in which each data is stored based on and/or in response to each encryption request.

Referring to the above-described configurations, the scheduler 112a may store the plurality of encryption requests REQs sequentially received in the request buffer 211. Additionally, the scheduler 112a may store the encryption requests, of which the encryption variable is not stored in the cache memory 101, in the wait buffer 212, from among the plurality of encryption requests REQs which are sequentially received.

Additionally, the scheduler 112a may output the encryption request, of which an encryption variable is generated, from among encryption requests stored in the wait buffer 212, while the scheduler 112a sequentially outputs the encryption requests stored in the cache memory 101.

Furthermore, the encryption circuit 111 may sequentially encrypt data received from the memory device 120 based on and/or in response to the encryption request sequentially output by the scheduler 112a.

That is, while the electronic circuit 110 is first performing the encryption in response to the encryption request of which the encryption variable is stored from among the plurality of encryption requests REQs, the electronic circuit 110 may generate the encryption variable in response to the encryption request of which the encryption variable is not stored.

Therefore, the electronic circuit 110 may encrypt the data stored in the memory device 120 within a relatively short span of time compared to the case of performing the encryption after the electronic circuit 110 sequentially obtains the encryption variables for each of the plurality of encryption requests REQs. Additionally, since only a subset (e.g., one of the encryption variables) is stored in the cache memory 101, the size and/or resource requirements of the cache memory 101 may be maintained and/or reduced.

Accordingly, the electronic circuit 110 according to at least one embodiment of the present disclosure may reduce the time required to encrypt the data stored in the memory device 120 in response to the plurality of encryption requests REQs while maintaining a smaller cache memory 101.

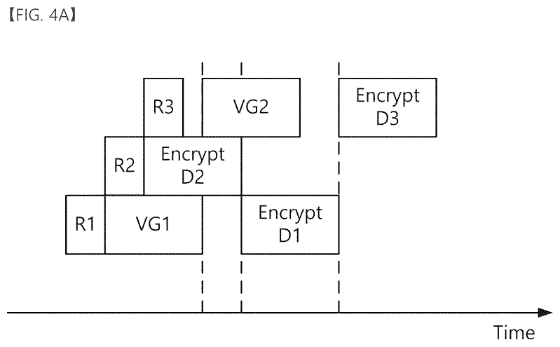

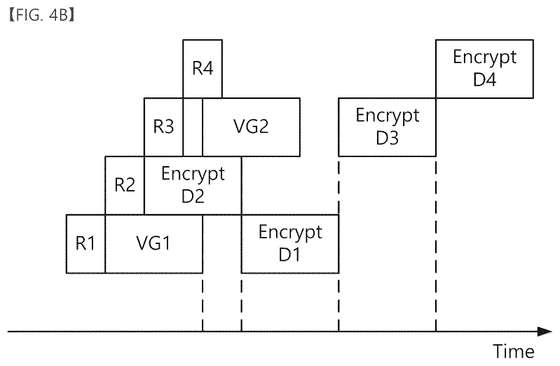

FIG. 4A illustrates processes in which the electronic circuit encrypts data stored in the memory device in response to each of the first encryption request to the third encryption request sequentially transmitted, according to at least one embodiment. FIG. 4B illustrates a configuration of encrypting fourth data in response to a fourth encryption request transmitted following the third encryption request R3, according to at least one embodiment.

Referring to FIG. 4A and FIG. 4B together, the electronic circuit 110 according to at least one embodiment may encrypt the data stored in an area in which each encryption request requires encryption in response to each of the encryption requests R1 to R4 sequentially received.

Referring to FIG. 4A, the electronic circuit 110 according to at least one embodiment may encrypt the first data D1 to third data D3 in response to sequentially receiving the first encryption request R1 to the third encryption request R3.

According to at least one embodiment, the encryption circuit 111 may sequentially receive the first encryption request R1 to the third encryption request R3 for the memory device 120 from the host interface 131.

For example, the encryption circuit 111 may sequentially receive, from the host 130, the first encryption request R1 for the first data D1 stored in the first area of the memory device 120, the second encryption request R2 for the second data D2 stored in the second area of the memory device 120, and the third encryption request R3 for the third data D3 stored in a third area of the memory device 120.

According to at least one embodiment, the electronic circuit 110 may first encrypt the second data D2 stored in the second area in response to the second encryption request R2 of which the encryption variable is stored from among the first encryption request R1 to the third encryption request R3 sequentially received.

Here, it is assumed that the cache memory 101 stores the second encryption variable for the second area and does not store the first encryption variable for the first area and does not store the third encryption variable for the third area.

For example, the electronic circuit 110 (and/or the encryption circuit 111) may encrypt the second data D2 stored in the second area based on the second encryption variable previously stored in the cache memory 101 based on and/or in response to the second encryption request R2.

Additionally, while the electronic circuit 110 encrypts the second data D2, the electronic circuit 110 may generate the first encryption variable corresponding to the first area based on and/or in response to the first encryption request R1 of which the encryption variable is not stored.

For example, the encrypting the second data D2 based on the second encryption variable and the generation of the first generation operation VG1 (generating the first encryption variable VAR1) may overlap. For example, while the electronic circuit 110 encrypts the second data D2 based on the second encryption variable, the electronic circuit 110 may perform the first generation operation VG1 for generating the first encryption variable VAR1.

Additionally, while the electronic circuit 110 encrypts the second data D2, the electronic circuit 110 may generate the third encryption variable corresponding to the third area based on and/or in response to the third encryption request R3 of which the encryption variable is not stored.

For example, the electronic circuit 110 may perform a second generation operation VG2 for generating the third encryption variable in response to a determination that the first encryption variable VAR1 is generated while the electronic circuit 110 encrypts the second data D2.

Additionally, the encryption circuit 111 may encrypt the first data D1 in response to a determination that the first encryption variable VAR1 is generated and encryption for the second data D2 is completed.

More specifically, in response to a determination that the first encryption variable VAR1 is generated at a time point when (or after) the encryption of the second data D2 is completed, the scheduler 112 may transmit the first encryption request R1 to the memory device 120.

Furthermore, the encryption circuit 111 may encrypt the first data D1 received from the memory device 120 based on the first encryption variable VAR1 based on and/or in response to the first encryption request R1.

Additionally, the encryption circuit 111 may encrypt the third data D3 in response to a determination that the third encryption variable is generated and that encryption of the first data D1 is completed.

More specifically, in response to a determination that the third encryption variable is generated at a time point when (or after) the encryption of the first data D1 is completed, the scheduler 112 may transmit the third encryption request R3 to the memory device 120.

Furthermore, the encryption circuit 111 may encrypt the third data D3 received from the memory device 120 based on the third encryption variable in response to the third encryption request R3.

According to at least one embodiment, when the cache memory 101 stores the third encryption variable for the third area, the encryption circuit 111 may encrypt the third data D3 based on the prestored third encryption variable.

For example, when the first encryption variable VAR1 is generated at the time point when the encryption of the second data D2 is completed, the scheduler 112 may transmit the first encryption request R1 to the memory device 120.

Furthermore, the encryption circuit 111 may encrypt the first data D1 received from the memory device 120 based on and/or in response to the first encryption request R1.

For another example, when the first encryption variable VAR1 is not generated at the time point when the encryption of the second data D2 is completed, the scheduler 112 may transmit the third encryption request R3 to the memory device 120. In other words, the scheduler may transmit the first encryption request R1 or third encryption request R3 based on the readiness of the first encryption variable VAR1.

Furthermore, the encryption circuit 111 may encrypt the third data D3 received from the memory device 120 based on and/or in response to the third encryption request R3.

Additionally, referring to FIG. 4B, according to at least one embodiment, when the encryption circuit 111 receives an additional encryption request (e.g., a fourth encryption request R4 following the third encryption request R3), the encryption circuit 111 may encrypt fourth data D4 based on a fourth encryption variable.

More specifically, when the encryption circuit 111 receives the fourth encryption request R4 following the third encryption request R3, the fourth data D4 may be encrypted based on the fourth encryption variable previously stored in the cache memory 101.

Here, the example provides that the cache memory 101 stores the fourth encryption variable for the fourth area.

For example, the encryption circuit 111 may encrypt the fourth data D4 in response to the end of the encryption of the third data D3.

Referring to the above-described configurations, when the electronic circuit 110 sequentially receives the first encryption request R1 to the fourth encryption request R4, the electronic circuit 110 may first encrypt the second data D2 stored in the second area based on the second encryption variable stored in the cache memory 101.

Additionally, the electronic circuit 110 may sequentially generate the first encryption variable VAR1 and a third encryption variable VAR3 not stored in the cache memory 101 while (e.g., in parallel to) the electronic circuit 110 encrypts the second data D2 based on the previously stored second encryption variable.

Furthermore, the electronic circuit 110 may sequentially encrypt the first data D1 and the third data D3 in response to a determination that each encryption variable is generated. Additionally, the electronic circuit 110 may encrypt the fourth data D4 in response to the encryption of the third data D3.

That is, the electronic circuit 110 may generate the encryption variable in response to the encryption request of which the encryption variable is not stored from among the plurality of encryption requests while the electronic circuit 110 is first performing the encryption in response to the encryption request of which the encryption variable is stored.

Furthermore, the electronic circuit 110 may sequentially encrypt the data based on the encryption variable generated while performing the encryption based on the prestored encryption variable.

Through this, the electronic circuit 110 according to at least one embodiment of the present disclosure may reduce the time required to encrypt the data stored in the memory device 120 in response to the plurality of encryption requests R1 and R2.

Additionally, the electronic circuit 110 may improve the encryption performance (e.g., the speed) for encrypting the data stored in the memory device 120 while the size of the cache memory 101 (or the electronic circuit 110) is maintained (and/or reduced).

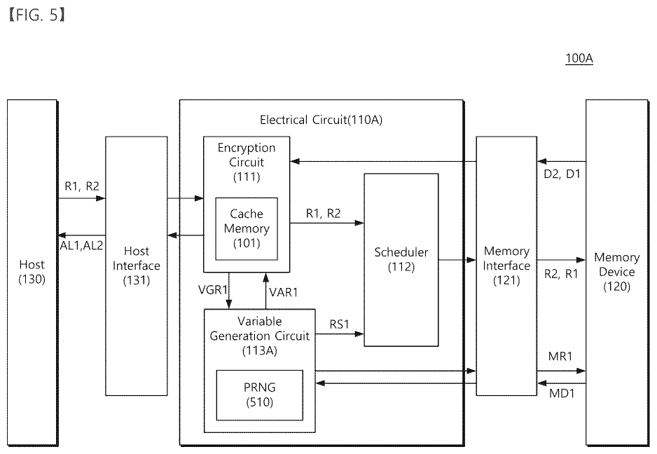

FIG. 5 is a block diagram illustrating the electronic circuit further including a random number generating circuit, according to at least one embodiment.

Referring to FIG. 5, a memory system 100A according to at least one embodiment may include an electronic circuit 110A, the memory device 120, and the host 130.

Here, the memory system 100A of FIG. 5 may be understood as an example of the memory system 100 illustrated in FIG. 1A and FIG. 1B. Accordingly, the same reference numerals are used for configurations which are the same as or substantially the same as the above-described configurations, and descriptions overlapping the above-described contents may be omitted for brevity and/or repeated for clarity and/or emphasis.

The electronic circuit 110A may include the encryption circuit 111, the scheduler 112, and a variable generation circuit 113A.

According to at least one embodiment, the encryption circuit 111 may receive the encryption requests R1 and R2 for the memory device 120 from the host 130.

For example, the encryption circuit 111 may sequentially receive the first encryption request R1 for the first data D1 stored in the first area of the memory device 120 and the second encryption request R2 for the second data D2 stored in the second area from the host 130.

Additionally, the encryption circuit 111 may transmit the received encryption requests R1 and R2 to the scheduler 112.

The scheduler 112 may first transmit, to the memory device 120, the second encryption request R2 of which the second encryption variable is previously stored from among the encryption requests R1 and R2 received from the encryption circuit 111.

Subsequently, the encryption circuit 111 may encrypt the second data D2 received from the memory device 120 based on the prestored second encryption variable based on and/or in response to the second encryption request R2.

Additionally, the encryption circuit 111 may transmit a generation request to generate the encryption variable to the variable generation circuit 113A in response to the encryption request of which the encryption variable corresponding to the area requesting encryption is not stored in the cache memory 101.

For example, when the first encryption variable VAR1 is not stored in the cache memory 101, the encryption circuit 111 may transmit the first generation request VGR1 for the first encryption variable VAR1 to the variable generation circuit 113A.

Additionally, the electronic circuit 110A may include the variable generation circuit 113A which is configured to generate the encryption variable for each of the plurality of areas of the memory device 120.

For example, the variable generation circuit 113A may generate the first encryption variable VAR1 corresponding to the first area of the memory device 120 in response to the first generation request VGR1 transmitted from the encryption circuit 111.

The variable generation circuit 113A may transmit the first meta request MR1 requesting the first metadata MD1 to the memory device 120 in response to the first generation request VGR1.

In response to the first meta request MR1, the memory device 120 may transmit the stored first metadata MD1 corresponding to the first encryption variable VAR1 to the variable generation circuit 113A (or the electronic circuit 110).

Additionally, the variable generation circuit 113A may further include a random number generation circuit (PRNG) 510.

The random number generation circuit 510 according to at least one embodiment may be configured to output a random number based on a specified (e.g., a preset and/other otherwise determined) probability.

For example, the random number generation circuit 510 may generate a pseudo random number based on the specified probability. Accordingly, the random number generation circuit 510 may be referred to as a “pseudo random number generator (PRNG)”.

Therefore, the variable generation circuit 113A may generate the first encryption variable VAR1 based on at least the first metadata MD1 received from the memory device 120 and the random number generated from the random number generation circuit 510.

Here, the variable generation circuit 113A may generate the first encryption variable VAR1 while the encryption circuit 111 encrypts data (e.g., the second data D2) based on an encryption variable which is prestored in the cache memory 101 (e.g., the second encryption variable).

Additionally, the variable generation circuit 113A may transmit the first encryption variable VAR1 to the encryption circuit 111 in response to a determination that the first encryption variable VAR1 is generated.

Additionally, in response to a determination that the first encryption variable VAR1 is generated, the variable generation circuit 113A may transmit the first preparation signal RS1 including the information that the first encryption variable VAR1 is generated to the scheduler 112.

Furthermore, the scheduler 112 may transmit the first encryption request R1 to the memory device 120 in response to the first preparation signal RS1.

Additionally, the encryption circuit 111 may encrypt the first data D1 received from the memory device 120 based on the first encryption variable VAR1 based on and/or in response to the first encryption request R1.

Referring to the above-described configurations, while the electronic circuit 110A is performing the encryption in response to the encryption request of which the encryption variable is stored, the electronic circuit 110A may generate the encryption variable in response to the encryption request of which the encryption variable is not stored, from among the plurality of encryption requests.

Therefore, the electronic circuit 110A according to at least one embodiment of the present disclosure may reduce the time required to encrypt the data stored in the memory device 120 in response to the plurality of encryption requests R1 and R2, while the size of cache memory 101 (or the electronic circuit 110A) is maintained (and/or reduced).

Additionally, the variable generation circuit 113A according to at least one embodiment may generate the encryption variable based on the random number generated according to the specified probability from the random number generation circuit 510.

Therefore, the electronic circuit 110A according to at least one embodiment of the present disclosure may enhance security of the data of the memory device 120 encrypted by the encryption variable.

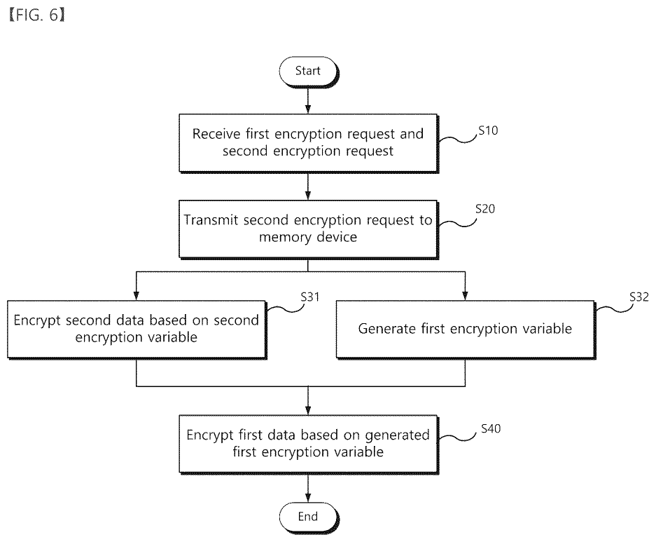

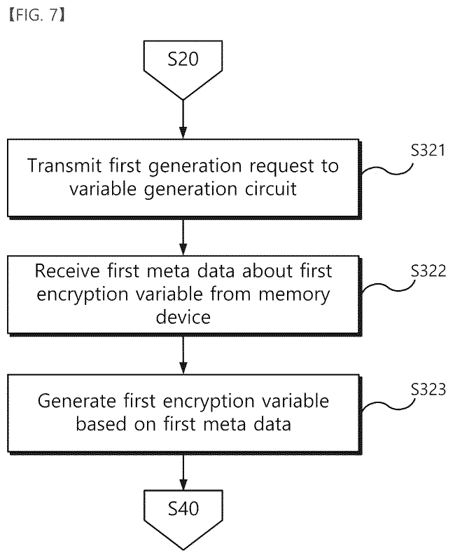

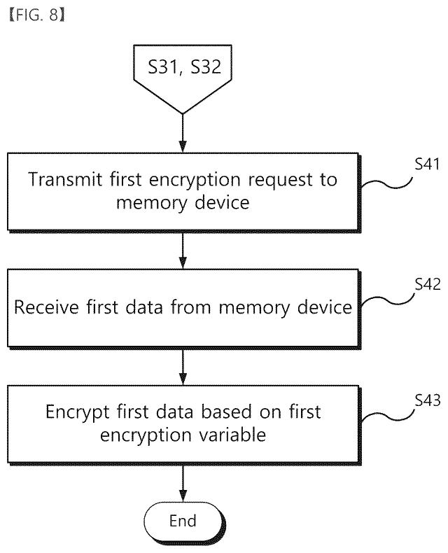

FIG. 6 is a flowchart illustrating a method of encrypting a memory device, according to at least one embodiment. FIG. 7 is a flowchart illustrating a method of generating the first encryption variable (operation S32 of FIG. 6), according to at least one embodiment. FIG. 8 is a flowchart illustrating a method of encrypting the first data based on and/or in response to the first encryption request (operation S40), according to at least one embodiment.

Referring to FIG. 6 to FIG. 8 together, the electronic circuit 110 (or the memory system 100) according to at least one embodiment may encrypt the data stored in the plurality of areas of the memory device 120 in response to the plurality of encryption requests R1 and R2.

In operation S10, the electronic circuit 110 receives the first encryption request R1 and the second encryption request R2.

More specifically, the electronic circuit 110 (or the encryption circuit 111) may receive the first encryption request R1 for the first data D1 stored in the first area of the memory device 120 and the second encryption request R2 for the second data D2 stored in the second area of the memory device 120 from the host 130.

Here, for example, the electronic circuit 110 may sequentially receive the first encryption request R1 for the first area and the second encryption request R2 for the second area of the memory device 120.

In operation S20, the electronic circuit 110 transmits the second encryption request R2 to the memory device 120.

More specifically, when the prestored encryption variable stored in the cache memory 101 is the second encryption variable, the electronic circuit 110 (or the scheduler 112) may transmit the second encryption request R2 requesting the encryption for the second area of the encryption requests R1 and R2 to the memory device 120.

In other words, in the example, the cache memory 101 does not store the first encryption variable for the first area, but stores the second encryption variable for the second area.

That is, the electronic circuit 110 may first transmit the encryption request of which the encryption variable for the area requesting encryption from among the received encryption requests R1 and R2 is stored in the cache memory 101 to the memory device 120.

Furthermore, in operation S31, the electronic circuit 110 encrypts the second data D2 based on the second encryption variable.

More specifically, the electronic circuit 110 may encrypt the second data D2 received from the memory device 120 based on and/or in response to the second encryption request R2 based on the prestored second encryption variable.

Additionally, in operation S32, the electronic circuit 110 generates the first encryption variable VAR1.

More specifically, referring to FIG. 6 and FIG. 7 together, the electronic circuit 110 may generate the first encryption variable VAR1 based on the first metadata MD1 stored in the memory device 120 (S32) corresponding to the first encryption variable VAR1.

In operation S321, the encryption circuit 111 transmits the first generation request VGR1 to the variable generation circuit 113.

More specifically, when the first encryption variable VAR1 is not stored in the cache memory 101, the encryption circuit 111 may transmit the first generation request VGR1 to the variable generation circuit 113.

In operation S322, the variable generation circuit 113 receives the first metadata MD1 associated with the first encryption variable VAR1 from the memory device 120.

More specifically, the variable generation circuit 113 may transmit the first meta request MR1 requesting the first metadata MD1 to the memory device 120 in response to the first generation request VGR1.

Additionally, in response to the first meta request MR1, the memory device 120 may transmit the stored first metadata MD1 corresponding to the first encryption variable VAR1 to the variable generation circuit 113 (or the electronic circuit 110).

Furthermore, in operation S323, the variable generation circuit 113 generates the first encryption variable VAR1 based on the first metadata MD1 received from the memory device 120.

According to at least one embodiment, the variable generation circuit 113 may further include the random number generation circuit 510 for generating the random number according to the specified probability.

In this case, the variable generation circuit 113 may generate the first encryption variable VAR1 based on the first metadata MD1 and the random number generated from the random number generation circuit 510.

According to at least one embodiment, the variable generation circuit 113 may transmit a signal for requesting the first encryption variable VAR1 to the memory device 120 in response to the first generation request VGR1.

Additionally, the memory device 120 may transmit the first encryption variable VAR1 to the variable generation circuit 113 (and/or the electronic circuit 110) in response to the signal received from the electronic circuit 110.

According to at least one embodiment, while the encryption circuit 111 encrypts the second data D2 based on the second encryption variable, the variable generation circuit 113 may generate the first encryption variable VAR1 in response to the first encryption request R1.

That is, in operation S31 and operation S32 according to at least one embodiment, at least some of each operation may be simultaneously performed (e.g., in parallel).

Additionally, the variable generation circuit 113 may transmit the first encryption variable VAR1 to the encryption circuit 111.

In operation S40, the electronic circuit 110 encrypts the first data D1 based on the generated first encryption variable VAR1.

More specifically, referring to FIG. 6 and FIG. 8 together, the electronic circuit 110 (or the scheduler 112) may encrypt the first data D1 in response to a determination that the first encryption variable VAR1 is generated (S40).

In operation S41, the scheduler 112 according to at least one embodiment transmits the first encryption request R1 to the memory device 120.

More specifically, the scheduler 112 may transmit the first encryption request R1 stored in the wait buffer 212 to the memory device 120 in response to a determination that the first preparation signal RS1 is received from the variable generation circuit 113.

Here, the first preparation signal RS1 may be understood as the signal which is output to the scheduler 112a in response to a determination that the first encryption variable VAR1 is generated by the variable generation circuit 113.

Additionally, the memory device 120 may transmit the first data D1 stored in the first area to the electronic circuit 110 in response to the first encryption request R1.

Therefore, in operation S42, the electronic circuit 110 according to at least one embodiment receives the first data D1 from the memory device 120.

Additionally, in operation S43, the encryption circuit 111 according to at least one embodiment encrypts the first data D1 based on the first encryption variable VAR1.

More specifically, the encryption circuit 111 may encrypt the first data D1 received from the memory device 120 based on the first encryption variable VAR1 generated through the variable generation circuit 113.

Referring to the above-described configurations, when the electronic circuit 110 sequentially receives the first encryption request R1 and the second encryption request R2, the electronic circuit 110 may encrypt the second data D2 based on the second encryption variable stored in the cache memory 101.

Additionally, while the electronic circuit 110 encrypts the second data D2 based on the previously stored second encryption variable, the electronic circuit 110 may generate the first encryption variable VAR1 not stored in the cache memory 101.

Furthermore, the electronic circuit 110 may encrypt the first data D1 in response to a determination that the encryption of the second data D2 is completed and the first encryption variable VAR1 is generated.

That is, while the electronic circuit 110 is first performing the encryption in response to the encryption request of which the encryption variable is stored from among the plurality of encryption requests, the electronic circuit 110 may generate the encryption variable in response to the encryption request of which the encryption variable is not stored.

Therefore, the electronic circuit 110 according to at least one embodiment of the present disclosure may reduce the time required to encrypt the data stored in the memory device 120 in response to the plurality of encryption requests R1 and R2 while the size of cache memory 101 (or the electronic circuit 110) is maintained (and/or reduced).

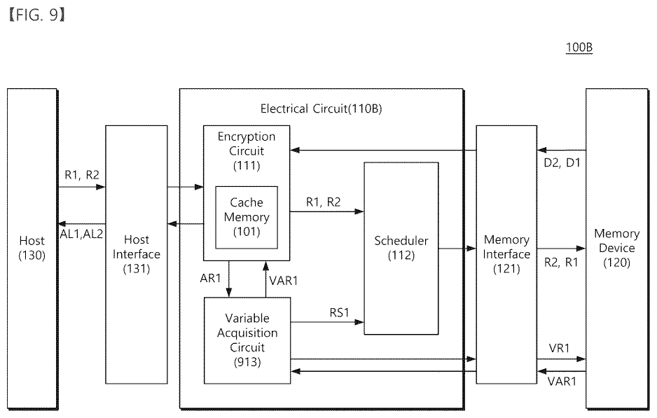

FIG. 9 is a flowchart illustrating the memory system including a system-on-chip including a variable acquisition circuit, according to another embodiment.

Referring to FIG. 9, a memory system 100B according to at least one embodiment may include an electronic circuit 110B, the memory device 120, and the host 130.

Here, the electronic circuit 110B may communicate with the host 130 through the host interface 131. Additionally, the electronic circuit 110A may communicate with the memory device 120 through the memory interface 121.

Here, the memory system 100B of FIG. 9 may be understood as an example of the memory system 100 illustrated in FIG. 1A and FIG. 1B. Accordingly, the same reference numerals are used for configurations which are the same as or substantially the same as the above-described configurations, and descriptions overlapping the above-described contents are omitted for brevity and/or repeated for clarity and/or emphasis.

The electronic circuit 110B may include the encryption circuit 111, the scheduler 112, and a variable acquisition circuit 913.

According to at least one embodiment, the encryption circuit 111 may receive the encryption requests R1 and R2 for the memory device 120 from the host 130.

For example, the encryption circuit 111 may sequentially receive the first encryption request R1 for the first data D1 stored in the first area of the memory device 120 and the second encryption request R2 for the second data D2 stored in the second area from the host 130.

Additionally, the encryption circuit 111 may transmit the received encryption requests R1 and R2 to the scheduler 112.

The scheduler 112 may first transmit the second encryption request R2 of which the second encryption variable is previously stored from among the encryption requests R1 and R2 received from the encryption circuit 111.

Subsequently, the encryption circuit 111 may encrypt the second data D2 received from the memory device 120 based on the prestored second encryption variable based on and/or in response to the second encryption request R2.

Additionally, the encryption circuit 111 may transmit the request for generating the encryption variable to the variable acquisition circuit 913 in response to the encryption request of which the encryption variable corresponding to the area requesting encryption is not stored in the cache memory 101.

For example, when the first encryption variable VAR1 is not stored in the cache memory 101, the encryption circuit 111 may transmit a first acquisition request AR1 for the first encryption variable VAR1 to the variable acquisition circuit 913 in response to the first encryption request R1.

The electronic circuit 110B may include the variable acquisition circuit 913 configured to generate the encryption variable for each of the plurality of areas of the memory device 120.

According to at least one embodiment, the variable acquisition circuit 913 may acquire the first encryption variable VAR1 corresponding to the first area of the memory device 120 in response to the first acquisition request AR1 transmitted from the encryption circuit 111.

The variable acquisition circuit 913 may transmit a first variable request VR1 requesting the first encryption variable VAR1 to the memory device 120 in response to the first acquisition request AR1.

Here, the memory device 120 may transmit the first encryption variable VAR1 of the first area to the variable acquisition circuit 913 (or the electronic circuit 110) in response to the first variable request VR1.

Accordingly, the variable acquisition circuit 913 may acquire the first encryption variable VAR1 from the memory device 120.

Here, while the encryption circuit 111 encrypts the second data D2 based on the second encryption variable, the variable acquisition circuit 913 may acquire the first encryption variable VAR1 from the memory device 120.

Furthermore, the variable acquisition circuit 913 may transmit the first encryption variable VAR1 to the encryption circuit 111 in response to a determination that the first encryption variable VAR1 is acquired.

Additionally, in response to a determination that the first encryption variable VAR1 is acquired, the variable acquisition circuit 913 may transmit the first preparation signal RS1 including the information that the first encryption variable VAR1 is acquired to the scheduler 112.

Furthermore, the scheduler 112 may transmit the first encryption request R1 to the memory device 120 in response to the first preparation signal RS1.

Additionally, the encryption circuit 111 may encrypt the first data D1 received from the memory device 120 based on the first encryption variable VAR1 based on and/or in response to the first encryption request R1.

Referring to the above-described configurations, while the electronic circuit 110B is performing the encryption in response to the encryption request of which the encryption variable is stored from among the plurality of encryption requests, the electronic circuit 110B may acquire the encryption variable in response to the encryption request of which the encryption variable is not stored.

Therefore, the electronic circuit 110B according to at least one embodiment of the present disclosure may reduce the time required to encrypt the data stored in the memory device 120 in response to the plurality of encryption requests R1 and R2, while the size of cache memory 101 (or the electronic circuit 110B) is maintained (and/or reduced).

As described above, when the electronic circuit 110 (and/or 110A and/or 110B) according to at least one embodiment of the present disclosure sequentially receives the first encryption request R1 and the second encryption request R2, the electronic circuit 110 may encrypt the second data D2 based on the second encryption variable stored in the cache memory 101.

Additionally, the electronic circuit 110 (and/or 110A and/or 110B) may generate the first encryption variable VAR1 not stored in the cache memory 101 while the electronic circuit 110 encrypts the second data D2 based on the previously stored second encryption variable.

Furthermore, the electronic circuit 110 (and/or 110A and/or 110B) may encrypt the first data D1 in response to a determination that the encryption of the second data D2 is completed and the first encryption variable VAR1 is generated.

That is, while the electronic circuit 110 (and/or 110A and/or 110B) is first performing the encryption in response to the encryption request of which the encryption variable is stored, the electronic circuit 110 (and/or 110A and/or 110B) may generate the encryption variable in response to the encryption request of which the encryption variable is not stored from among the plurality of encryption requests.

Through this, the electronic circuit 110 (and/or 110A and/or 110B) according to at least one embodiment of the present disclosure may reduce the time required to encrypt the data stored in the memory device 120 in response to the plurality of encryption requests R1 and R2.

Additionally, the electronic circuit 110 may improve the encryption performance (e.g., the speed) for encrypting the data stored in the memory device 120 while the size of cache memory 101 (or the electronic circuit 110) is maintained (or reduced).

The electronic circuit according to the present disclosure may reduce the time required to encrypt the data stored in the memory device in response to the plurality of encryption requests.

In addition to the above-described embodiments, embodiments which may be simply designed or easily changed will be included in the present disclosure. Additionally, the present disclosure will also include technologies which may be easily modified and implemented by using embodiments. Therefore, the scope of the present disclosure should not be limited to the above-described embodiments, but should be determined not only by the scope of the claims to be described later but also by those which are equivalent to the scope of the claims of this disclosure.

In addition, the functional elements described above, such as those including “unit”, “ . . . er/or”, “circuit”, “host”, “logic”, etc., described in the specification refer to elements that process at least one function or operation, and may be implemented as processing circuitry such as hardware, software, or a combination of hardware and software, unless expressly indicated otherwise. For example, the processing circuitry more specifically may include, but is not limited to, electrical components such as at least one of transistors, resistors, capacitors, etc., /or electronic circuits including said components, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. and/or may include active and/or passive components such as gates, transistors, resistors, capacitors, etc., and/or electronic circuits including one or more of said components.

While the present disclosure has been described with reference to example embodiments thereof, it will be apparent to those of ordinary skill in the art that various changes and modifications may be made thereto without departing from the spirit and scope of the present disclosure as set forth in the following claims.

What is claimed is:

1. An electronic circuit configured to communicate with a memory device, comprising:
an encryption circuit including a cache memory storing an encryption variable for some of a plurality of areas of the memory device, and configured to receive a plurality of encryption requests including a first encryption request for first data stored in a first area of the plurality of areas of the memory device and a second encryption request for second data stored in a second area of the plurality of areas of the memory device;
a scheduler configured to transmit the second encryption request to the memory device when a first encryption variable for the first area is not stored in the cache memory and a second encryption variable for the second area is stored in the cache memory; and
a variable generation circuit configured to generate the first encryption variable while the encryption circuit encrypts the second data received from the memory device based on the second encryption variable in response to the second encryption request,
wherein the scheduler transmits the first encryption request to the memory device in response to a determination that the first encryption variable is generated.

2. The electronic circuit of claim 1, wherein the encryption circuit is configured to:
receive the second data from the memory device; and
encrypt the second data based on the second encryption variable.

3. The electronic circuit of claim 2, wherein the encryption circuit is configured to:
transmit a first generation request to the variable generation circuit when the first encryption variable is not stored in the cache memory;
acquire the first encryption variable from the variable generation circuit;
receive the first data from the memory device; and
encrypt the first data based on the first encryption variable in response to a determination that the encryption of the second data is completed.

4. The electronic circuit of claim 3, wherein the variable generation circuit is configured to:
acquire first metadata for the first area from the memory device in response to the first generation request; and
generate the first encryption variable for the first area based on the first metadata.

5. The electronic circuit of claim 4, wherein the variable generation circuit further includes a random number generation circuit configured to output a random number based on a probability,
wherein the variable generation circuit is configured to generate the first encryption variable based on the random number output from the random number generation circuit and the first metadata.

6. The electronic circuit of claim 4, wherein the variable generation circuit is configured to store location information on a location of the memory device, at which the first metadata for the first area is stored.

7. The electronic circuit of claim 1, wherein the scheduler includes:
a request buffer configured to store encryption requests, from among the plurality of encryption requests, received through the encryption circuit;
a wait buffer configured to store encryption requests, from among the plurality of encryption requests, of which an encryption variable for an area requesting encryption is not stored in the cache memory; and
an output circuit configured to sequentially output the encryption requests stored in the request buffer and the wait buffer to the memory device.

8. The electronic circuit of claim 7, wherein the variable generation circuit is configured to transmit a first preparation signal to the scheduler in response to the determination that the first encryption variable is generated, and
wherein the wait buffer is configured to output the first encryption request to the output circuit in response to the first preparation signal.

9. The electronic circuit of claim 1, wherein, when the encryption circuit receives a third encryption request for a third area following the first encryption request and the second encryption request, and a third encryption variable for the third area is stored in the cache memory, the scheduler is configured to transmit one of the first encryption request or the third encryption request based on a determination of whether the first encryption is generated such that
the first encryption request is transmitted to the memory device at a time point when encryption of the second area is completed and the first encryption variable is generated; and
the third encryption request is transmitted to the memory device at a time point when the encryption of the second area is completed and the first encryption variable is not generated.

10. The electronic circuit of claim 1, wherein, when the encryption circuit receives a third encryption request for a third area following the first encryption request and the second encryption request, and a third encryption variable for the third area is not stored in the cache memory,
the variable generation circuit is configured to generate the third encryption variable, and
the scheduler is configured to transmit the third encryption request to the memory device in response to a determination that an encryption of the first area is completed and the third encryption variable is generated.

11. An encrypting method of a memory system including an electrical circuit and a memory device including a plurality of areas, the method comprising:
receiving a plurality of encryption requests including a first encryption request for first data stored in a first area of the plurality of areas and a second encryption request for second data stored in a second area of the plurality of areas;
transmitting the second encryption request to the memory device in response to a determination that a first encryption variable for the first area is not stored in a cache memory of the electrical circuit and a second encryption variable for the second area is stored in the cache memory;
generating the first encryption variable while encrypting the second data received from the memory device based on the second encryption variable; and
encrypting the first data based on the generated first encryption variable.

12. The method of claim 11, wherein the generating of the first encryption variable further includes:
transmitting a first generation request to a variable generation circuit of the electrical circuit in response to the determination that the first encryption variable is not stored in the cache memory;
receiving first metadata for the first encryption variable from the memory device in response to the first generation request; and
generating the first encryption variable based on the first metadata.

13. The method of claim 12, wherein the generating of the first encryption variable further includes:
generating a random number, based on a probability, in response to receiving the first metadata; and
generating the first encryption variable based on the first metadata and the random number.

14. The method of claim 11, wherein the encrypting of the first data further incudes:
transmitting the first encryption request to the memory device in response to a determination that the first encryption variable is generated;
receiving the first data from the memory device; and
encrypting the first data received from the memory device based on the first encryption variable after the encryption of the second data is completed.

15. The method of claim 11, further comprising:
receiving, after the first encryption request and the second encryption request, a third encryption request for third data stored in a third area of the plurality of areas; and
encrypting one of the first data or the third data based on a determination of whether the first encryption is generated, such that the first data is encrypted based on the first encryption variable at a time point when encryption for the second area is completed and in response to a determination that the first encryption variable is generated and the third data stored in the third area is encrypted based on a third encryption variable stored in the cache memory at a time point when the encryption for the second area is completed and in response to a determination that the first encryption variable is not generated.

16. An electronic circuit configured to communicate with a memory device including plurality of areas, comprising:
an encryption circuit including a cache memory storing an encryption variable for some of the plurality of areas of the memory device and configured to receive a first encryption request for first data stored in a first area of the plurality of areas and a second encryption request for second data stored in a second area of the plurality of areas;
a scheduler configured to transmit the second encryption request to the memory device when a first encryption variable for the first area is not stored in the cache memory and a second encryption variable for the second area is stored in the cache memory; and
a variable acquisition circuit configured to receive the first encryption variable from the memory device,
wherein the electronic circuit is configured such that the encryption circuit encrypts the second data received from the memory device based on the second encryption variable in response to the second encryption request while the variable acquisition circuit receives the first encryption variable, and
wherein the scheduler is configured to transmit the first encryption request to the memory device in response to a determination that the first encryption variable is received by the variable acquisition circuit.

17. The electronic circuit of claim 16, wherein the encryption circuit is configured to:
receive the second data from the memory device; and
encrypt the second data based on the second encryption variable and the second data.

18. The electronic circuit of claim 17, wherein the encryption circuit is configured to:
transmit first acquisition request to the variable acquisition circuit in response to a determination that the first encryption variable is not stored in the cache memory;
acquire the first encryption variable through the variable acquisition circuit;
receive the first data from the memory device in response to a determination that encryption of the second data is completed; and
encrypt the first data based on the first encryption variable and the first data.

19. The electronic circuit of claim 16, wherein the variable acquisition circuit is configured to transmit a first preparation signal to the scheduler in response to a determination that the first encryption variable is acquired from the memory device, and
wherein the scheduler is configured to transmit the first encryption request to the memory device in response to the first preparation signal.

20. The electronic circuit of claim 18, wherein, while the encryption circuit encrypts the second data, the variable acquisition circuit is configured to:
transmit a first variable request to the memory device; and
acquire the first encryption variable from the memory device.
